(19) United States
(12) Patent Application Publication
(10) Pub. No.: US 2005/0096896 A1
(43) Pub. Date: May 5, 2005

(54) Method and apparatus for performing on-screen emulation of a device

(76) Inventor: Louis Leclerc, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/696,921

(22) Filed: Oct. 30, 2003

(51) Int. Cl. G06F 9/455

(52) U.S. Cl. 703/23; 703/26

(57) ABSTRACT

A system may comprise at least one device information file that contains emulation information about at least one device and an emulator that is adapted to read the at least one device information file and provide an on-screen display (“OSD”) emulation of the at least one device. A method may comprise the acts of identifying a device information file that comprises emulation information about a set-up procedure associated with at least one device, invoking an emulation of the set-up procedure associated with the device based on the emulation information and providing instruction to a user based on the emulation of the set-up procedure.

### BACKGROUND OF THE RELATED ART

Tis section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Many companies are engaged in the business of selling complex products, such as appliances, consumer electronics, computer systems and components thereof, for example. Customers who buy these products are frequently unfamiliar with the details of the operation of the products. Customers may not understand the process of how to set up a product that they have purchased and place it in working order. The video cassette recorder (“VCR”) clock is a familiar example. VCRs are complicated devices, and many people are not familiar with the details of their operation. Thus, individuals may choose to use their VCRs to play tapes without ever setting the clock.

In other cases, however, customers may become frustrated with a device if they are unable to get it to operate correctly. They may even choose to return the device for a refund instead of enduring the aggravation of getting the device to work. Unfortunately, customers may even return devices that are not broken or defective, which has the effect of increasing costs to manufacturers and sellers of the devices.

In an effort to assist customers and minimize costs related to returned devices, companies may establish call centers to receive calls from customers who are in the process of setting up purchased devices. Support people at the call center may be trained to guide customers successfully through the process of setting up their devices and getting them to operate correctly. For example, call center employees may be familiar with the documentation that comes with their company's products and may be able to direct the customer to the appropriate place in that documentation to address the particular problem faced by the customer.

A problem may arise, however, if the customer is unable to effectively communicate the status of a device or explain the specific difficulty that is being experienced to the call center support person. In many cases, the call center support person, while knowledgeable, does not have access to a device that is just like the customer's device. This problem may be compounded if the company sells many devices that require different set-up procedures. It may be impossible for call center employees to be familiar with each and every device sold by their company, as well as the set-up procedures for each device. Call center employees may not be able to help their customers because the call center employee may not be able to duplicate the difficulty the customer is experiencing. If the call center employee is not able to help the customer set up their device, the customer may return the device for a refund even though the device may not be broken or defective.

### BRIEF DESCRIPTION OF THE DRAWINGS

Advantages of one or more disclosed embodiments may become apparent upon reading the following detailed description and upon reference to the drawings in which:

FIG. 1 is a block diagram of a processor-based system that may be used in connection with embodiments of the present invention;

FIG. 2 is a block diagram that illustrates an on-screen display (“OSD”) emulation system in accordance with embodiments of the present invention;

FIG. 3 is a diagram that illustrates an exemplary on-screen display emulation in accordance with embodiments of the present invention; and

FIG. 4 is a flow diagram that illustrates a process in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

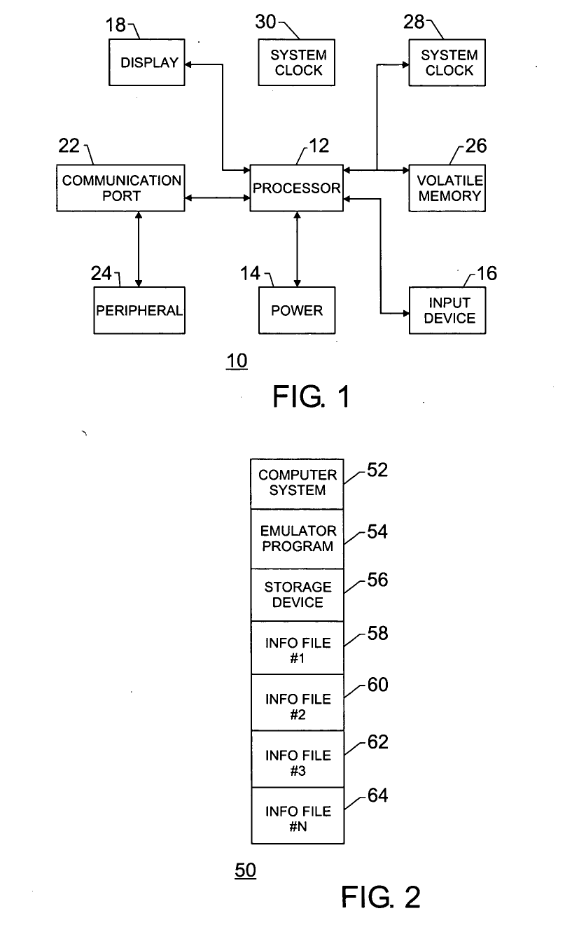

The disclosed embodiments relate to a system and method for providing an on-screen display (“OSD”) emulation that corresponds to one or more other devices. OSD emulation in accordance with embodiments of the present invention may be employed by remote employees, such as call center operators and the like, to reproduce a visual display or other feedback that a customer sees or otherwise receives when the customer is trying to set up a newly purchased device, such as a computer system or computer monitor, for example. An OSD system in accordance with embodiments of the present invention may allow the call center operator to provide effective feedback to customers regarding a large number of devices. The OSD system of the present invention may be applicable to a wide range of devices, such as the exemplary device illustrated in FIG. 1.

FIG. 1 illustrates a block diagram of a processor-based system that may be used in connection with embodiments of the present invention. The device is generally designated by the reference numeral 10. The device 10 may be any of a variety of different types, such as a computer, pager, cellular telephone, personal organizer or the like. In a typical processor-based device, a processor 12, such as a microprocessor, executes software to control the operation of the device 10.

The device 10 typically includes a power supply 14. If the device 10 is portable, the power supply 14 may include a fuel cell, permanent batteries, replaceable batteries, and/or rechargeable batteries. The power supply 14 may also include an AC adapter, so that the device may be powered from a wall outlet. The power supply 14 may also include a DC adapter, so that the device 10 may be plugged into a source of DC power such as the cigarette lighter receptacle in a vehicle.

Various other devices may be coupled to the processor 12, depending upon the functions that the device 10 performs. For instance, an input device 16 may be coupled to the processor 12. The input device 16 may include any type of device that allows a user to issue commands to the device 10. Examples of typical input devices include buttons, switches, a keyboard, a light pen, a mouse, and/or a voice recognition system. A display 18 may also be coupled to the processor 12. The display 18 may include a liquid crystal display (“LCD”) display, a cathode ray tube (“CRT”), light emitting diodes (“LEDs”), a plasma display, an audio display or the like. A communication port 22 may also be coupled to the processor 12. The communication port 22 may be adapted to be coupled to a peripheral input/output device 24, such as a modem, a printer, or a computer, for instance, or to a network, such as a local area network or the Internet.

Because the processor 12 controls the functioning of the device 10 generally under the control of programming (software, firmware, hardware or the like), memory devices may be coupled to the processor 12 to store the programming and other data. For instance, the processor 12 may be coupled to volatile memory 26, which may include dynamic random access memory (DRAM), static random access memory (SRAM) or the like. The processor 12 may also be coupled to non-volatile memory 28. The non-volatile memory 28 may include a read-only memory (ROM), such as an EPROM or flash memory, to be used in conjunction with the volatile memory. Additionally, the non-volatile memory 28 may include a high capacity memory such as a disk drive, tape drive memory, CD ROM drive, DVD, read/write CD ROM drive, and/or a floppy disk drive.

A system clock 30 may be connected to one or more of the components of the device 10. The connections between the system clock and other devices are not shown in FIG. 1 for purposes of clarity. Examples of components within the device 10 that may be connected to the system clock 30 include the processor 12, the non-volatile memory 28, and/or the volatile memory 26. The processor 12, the non-volatile memory 28, and the volatile memory 26 may be implemented as one or more integrated circuit components.

An OSD emulation system constructed in accordance with embodiments of the present invention may allow a call center employee to provide customers with feedback on the set-up and operation of the device 10 as a whole or one or more of the individual components of the device 10. For example, an OSD emulation system may be designed to provide assistance with video display devices, such as the display device 18 of the system 10. A company may sell many different video display devices, each having different features and set-up procedures. Such an OSD emulation system may be adapted to allow a call center employee to emulate the operation of any of the video display devices sold by the company. Thus, the call center employee would be able to provide feedback and assistance to customers who had purchased any of the different types of display devices without having samples of each type of display device at hand.

FIG. 2 is a block diagram that illustrates an OSD emulation system 50 in accordance with embodiments of the present invention. The OSD emulation system 50 may comprise a computer system 52, which may execute an emulator program 54. The emulator program 54 may be accessible in a web-based format via a network (including the Internet) or may be accessible from a local storage device 56, such as a CD-ROM drive.

For purposes of clarity, the computer system 52 is not to be confused with the device 10 (FIG. 1), which may be a computer system as well. The device 10 (FIG. 1) is intended to be illustrative of a device purchased by a customer for which the customer may seek assistance from a call center or the like. The OSD emulation system 50, including the computer system 52, is illustrative of a system or tool that may be employed by a call center employee or the like to emulate aspects of the operation of devices, which may include the device 10 (FIG. 1).

The emulator program 54 may employ one or more device information files or profiles. In FIG. 2, four device profiles are shown. Those profiles are identified as an information file #1 (58), an information file #2 (60), an information file #3 (62) and an information file #n (64). Each of the device profiles 58, 60, 62 and 64 may contain emulation information about a different device or group of devices. For example, the emulation information contained in the information file #1 (58) may relate to a particular computer display or a family of computer displays that have similar set-up procedures or operational characteristics.

The emulation information contained in the information file may be provided by the company that makes the device for which the information pertains. For example, a company may obtain a product from an outside supplier for resale to customers. If the company desires to provide its call centers with emulation information for that device, the company, may prepare a device information file for the device or ask the supplier to provide a device information file in a particular format so that call centers may employ the emulation information when supporting customers.

In operation, a call center employee may access a device information file corresponding to a customer's product during a call from the customer. The accessing of the device information file may be done when the emulator program 54 is invoked or after invocation from a menu or the like. The emulation information contained in the device information file may provide an on-screen display similar in appearance to what the customer sees when attempting to set up the device. In this manner, the call center employee may guide the customer through the set-up process and assist the customer in addressing problems and difficulties that may arise. For example, the call center employee may be able to compare the information that is being displayed to the customer with the information that should be displayed for a correct set-up procedure. If the information that the customer is seeing is different, the call center employee may be able to instruct the customer on how to correct the problem and return to a correct set-up status. In this manner, the call center employee may be able to help the customer and prevent a functional device from being returned in frustration. The OSD emulation system 50 may additionally allow the call center employee to identify cases in which a customer's device is genuinely broken or defective. In such cases, the call center employee may play a role in helping the customer effectively get service for the device in a way that minimizes the customer's frustration.

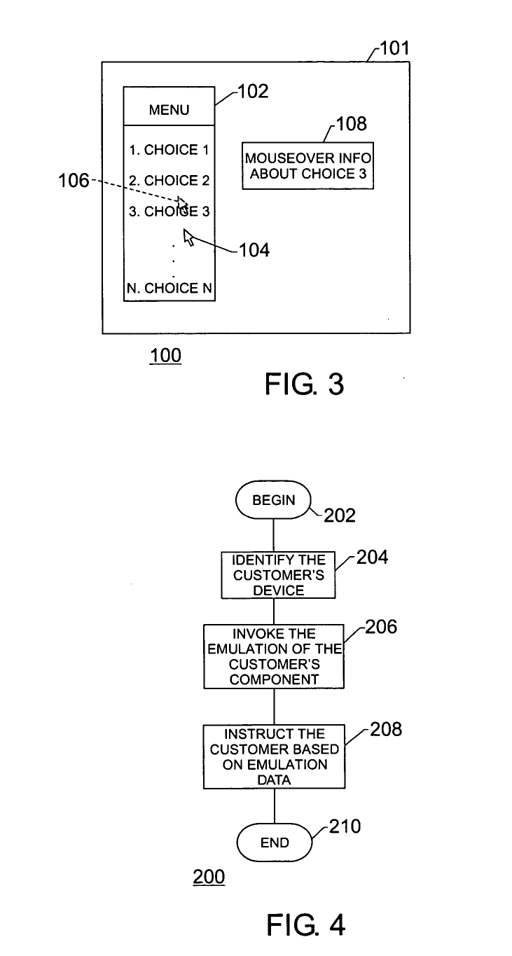

FIG. 3 is a diagram that illustrates an exemplary on-screen display emulation in accordance with embodiments of the present invention. The diagram is generally referred to by the reference numeral 100. An OSD emulation 101 corresponds to what a call center employee may see when using the OSD emulation system 50 (FIG. 2). To obtain the OSD emulation 101, the call center employee may select a device to emulate by selecting an item on a menu (not shown) or the like. The menu or list of devices that may be emulated may correspond to the device information files 58, 60, 62 and 64 (FIG. 2). In other words, each of the device information files 58, 60, 62 and 64 (FIG. 2) may present a different OSD emulation 101 for the call center employee, each of the different OSD emulations corresponding to a different device or set-up procedure.

After obtaining the OSD emulation 101, the call center employee may have access to a visual display that is similar to what the customer should see during a correct set-up procedure. For example, the OSD emulation 101 may comprise a menu 102 corresponding to a menu that should be displayed on a customer's device at a particular point in the set-up process. The menu may comprise a plurality of options, which are identified as choice 1, choice 2, choice 3 and choice n in FIG. 3.

The OSD emulation 101 may facilitate use of a pointing device such as a mouse or the like to provide additional information to the call center employee. For instance, a cursor 104 may respond to a mouse or other input device manipulated by the call center employee. Using the cursor 104, the call center employee may select an option from the options displayed in the emulation 101. When an option is selected, additional information about the selection may be made available to the call center employee,

By way of illustration, a cursor image 106 (shown in dashed lines) corresponds to a selection by the call center employee of choice 3 on the menu 102. When the call center employee places the cursor 106 in the vicinity of choice 3, the OSD emulation 101 may be adapted to provide a display of mouseover information 108 about choice 3. Likewise, mouseover information may be associated with choice 1, choice 2 and choice n, as well as the menu 102. The mouseover information 108, which may be contained in the corresponding device information file, may be information that is useful in correcting problems a customer is having with respect to choice 3 of the menu 102. Those of ordinary skill in the art will readily appreciate that the illustration of providing mouseover information is exemplary and not given by way of limitation. The use of other methods to provide relevant information to the call center employee may be a matter of design choice. Such other methods may include employing a touch screen, scroll data or the like.

FIG. 4 is a flow diagram that illustrates a process in accordance with embodiments of the present invention. The process is generally referred to by the reference numeral 200. At block 202, the process begins. At block 204, a call center employee who is trying to assist a customer with the set-up of a device identifies the customer's device. This may be done by obtaining the model number of the device from the customer or by any other suitable means. As another example, the call center employee may be able to obtain information about the type of device the customer is trying to set up from a warranty registration database or the like.

After the call center employee identifies the customer's device, the call center employee may invoke an OSD emulation system such as the OSD emulation system 50 (FIG. 2), as shown at block 206. The OSD emulation system may provide the call center employee with an OSD emulation such as the OSD emulation 101 (FIG. 3) for the selected device. The call center employee may then employ the OSD emulation to instruct the customer based on the emulation data stored in a device information file. At block 210, the process ends.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system, comprising:
at least one device information file that contains emulation information about at least one device; and
an emulator that is adapted to read the at least one device information file and provide an on-screen display (“OSD”) emulation of the at least one device.

2. The system set forth in claim 1, wherein the emulation comprises information relating to a set-up procedure of the at least one device.

3. The system set forth in claim 1, wherein the emulator is adapted to present the emulation in a manner that approximates information that would be presented by the at least one device during a set-up procedure of the at least one device.

4. The system set forth in claim 1, wherein the emulation comprises mouseover information about at least one option.

5. The system set forth in claim 1, wherein the at least one device comprises a computer display device.

6. The system set forth in claim 1, wherein the at least one device comprises a computer system.

7. The system set forth in claim 1, wherein the at least one device comprises a consumer electronics device.

8. The system set forth in claim 1, wherein the emulator is available via a network.

9. The system set forth in claim 1, wherein the emulator is available via a local CD-ROM drive.

10. A method, comprising the acts of:
identifying a device information file that comprises emulation information about a set-up procedure associated with at least one device;
invoking an emulator that is adapted to access the device information file and provide an emulation that is based on the emulation information; and
providing instruction to a user based on the emulation.

11. The method set forth in claim 10, comprising the act of providing an on-screen display (“OSD”) emulation based on the emulation information.

12. The method set forth in claim 10, comprising the act of defining the emulation to be presented in a manner that approximates an output provided by the at least one device.

13. The method set forth in claim 10, comprising the act of defining the emulation to comprise mouseover information about at least one set-up option.

14. The method set forth in claim 10, comprising the act of defining the at least one device to comprise a computer display device.

15. The method set forth in claim 10, comprising the act of defining the at least one device to comprise a computer system.

16. The method set forth in claim 10, comprising the act of defining the at least one device to comprise a consumer electronics device.

17. The method set forth in claim 10, comprising the act of accessing the emulator via a network.

18. The method set forth in claim 10, comprising the act of accessing the emulator via a local CD-ROM drive.

19. A system, comprising:
at least one device information file that contains emulation information about at least one device; and
means for providing an on-screen display (“OSD”) emulation of the at least one device based on the emulation information about the at least one device.

20. The system set forth in claim 19, wherein the emulation comprises information relating to a set-up procedure of the at least one device.

21. The system set forth in claim 19, wherein the means for providing an emulation is adapted to present the emulation in a manner that approximates information that would be presented by the at least one device during a set-up procedure of the at least one device.

22. The system set forth in claim 19, wherein the emulation comprises mouseover information about at least one option.

23. The system set forth in claim 19, wherein the at least one device comprises a computer display device.

24. The system set forth in claim 19, wherein the at least one device comprises a computer system.

25. The system set forth in claim 19, wherein the at least one device comprises a consumer electronics device.

26. A computer program, comprising:
a machine readable medium;
at least one device information file stored on the machine readable medium, the device information file containing emulation information about at least one device; and
an emulator stored on the machine readable medium, the emulator being adapted to read the at least one device information file and provide an emulation of a set-up procedure associated with the at least one device.

27. The computer program set forth in claim 26, wherein the device information file comprises information relating to the set-up procedure of the at least one device.

28. The computer program set forth in claim 26, wherein the device information file comprises mouseover information about at least one option.

29. The computer program set forth in claim 26, wherein the at least one device comprises a computer display device.

30. The computer program set forth in claim 26, wherein the at least one device comprises a computer system.

31. The computer program set forth in claim 26, wherein the at least one device comprises a consumer electronics device.

32. The computer program set forth in claim 26, wherein the machine readable medium comprises a network storage device.

33. The computer program set forth in claim 26, wherein the machine readable medium comprises a local CD-ROM drive.

34. The computer program set forth in claim 26, wherein the emulation comprises an on-screen display (“OSD”) emulation.
